(19) United States
(12) Patent Application Publication
(10) Pub. No.: US 2026/0238562 A1
(43) Pub. Date: Aug. 13, 2026

(54) COMMUNICATION METHOD AND COMMUNICATION APPARATUS, AND STORAGE MEDIUM

(71) Applicant: BEIJING XIAOMI MOBILE SOFTWARE CO., LTD., Beijing (CN)

(72) Inventor: Qin MU, Beijing (CN)

(73) Assignee: BEIJING XIAOMI MOBILE SOFTWARE CO., LTD., Beijing (CN)

(21) Appl. No.: 19/474,811

(22) PCT Filed: Apr. 13, 2023
(86) PCT No.: PCT/CN2023/088232

§ 371 Date: Oct. 13, 2025

(51) Int. Cl. H04L 41/16

(52) U.S. Cl. CPC H04L 41/16

(57) ABSTRACT

A communication method is provided, which includes: indicating model-related information of the first device to a second device; wherein the model-related information comprises at least one of: one or more artificial intelligence (AI) models supported by the first device; one or more AI functionalities associated with the one or more AI models supported by the first device; one or more AI functionalities supported by the first device; or one or more AI models associated with the one or more AI functionalities supported by the first device.

### CROSS-REFERENCE TO RELATED APPLICATIONS

The present application is a U.S. National Phase of International Application No. PCT/CN2023/088232, filed on Apr. 13, 2023, the content of which is incorporated herein by reference in its entirety.

### TECHNICAL FIELD

The disclosure relates to the field of communication technology, in particular to a communication method, an apparatus, a device and a storage medium.

### BACKGROUND

With the continuous development of artificial intelligence (AI) technology, the application fields of AI technology have become increasingly extensive. AI technology has also been introduced into the 3rd generation partnership project (3GPP). For example, AI models have been adopted to implement AI-based CSI enhancement, AI-based beam management, AI-based positioning, and other related functions.

In some scenarios, AI models are deployed on terminals, and network devices also need to participate in the management of AI models. Therefore, network devices and terminals must have a unified understanding of the relevant information about the AI models on the terminals.

### SUMMARY

The disclosure provide a communication method, an apparatus, a device and a storage medium.

According to a first aspect embodiments of the disclosure, a communication method is provided, which is performed by a first device. The method includes:
indicating model-related information of the first device to a second device;
in which the model-related information includes at least one of:
one or more AI models supported by the first device;
one or more AI functionalities associated with the one or more AI models supported by the first device;
one or more AI functionalities supported by the first device; or
one or more AI models associated with the one or more AI functionalities supported by the first device.

According to a second aspect embodiments of the disclosure, a communication method is provided, which is performed by a second device. The method includes:
determining model-related information of a first device based on an indication from the first device;
in which the model-related information includes at least one of:

one or more AI models supported by the first device;
one or more AI functionalities associated with the one or more AI models supported by the first device;
one or more AI functionalities supported by the first device; or
one or more AI models associated with the one or more AI functionalities supported by the first device.

According to a third aspect embodiments of the disclosure, a communication apparatus is provided, including a processor, and when the processor invokes a computer program in a memory, the processor executes any one of the methods described in the first aspect or the second aspect above.

According to a fourth aspect embodiments of the disclosure, a non-transitory computer-readable storage medium is provided for storing instructions which, when executed, cause the communication method described in the first aspect or the second aspect above to be implemented.

### BRIEF DESCRIPTION OF THE DRAWINGS

The above and/or additional aspects and advantages of the disclosure become apparent and easily understandable from the following description of the embodiments in conjunction with the accompanying drawings.

FIG. 1 is a schematic diagram of a communication system according to an embodiment.

FIG. 2 is a schematic flowchart of a communication method according to an embodiment.

FIG. 3 is a schematic flowchart of a communication method according to another embodiment.

FIG. 4 is a schematic flowchart of a communication method according to further another embodiment.

FIG. 5 is a schematic flowchart of a communication method according to yet another embodiment.

FIG. 6 is a schematic flowchart of a communication method according to yet another embodiment.

FIG. 7 is a schematic flowchart of a communication method according to yet another embodiment.

FIG. 8 is a schematic flowchart of a communication method according to yet another embodiment.

FIG. 9 is a schematic flowchart of a communication method according to yet another embodiment.

FIG. 10 is a schematic flowchart of a communication method according to yet another embodiment.

FIG. 11 is a schematic flowchart of a communication method according to yet another embodiment.

FIG. 12 is a schematic diagram of a communication apparatus according to an embodiment.

FIG. 13 is a schematic diagram of a communication apparatus according to another embodiment.

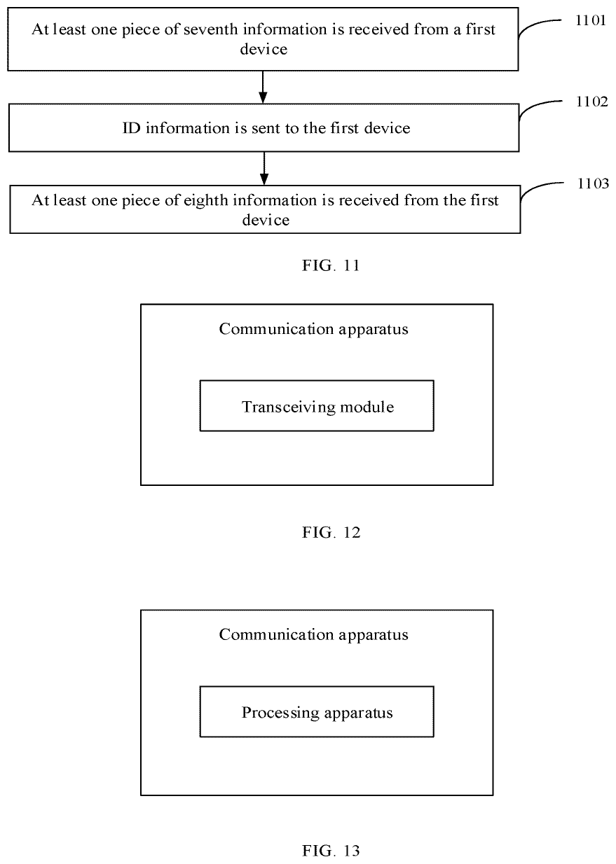

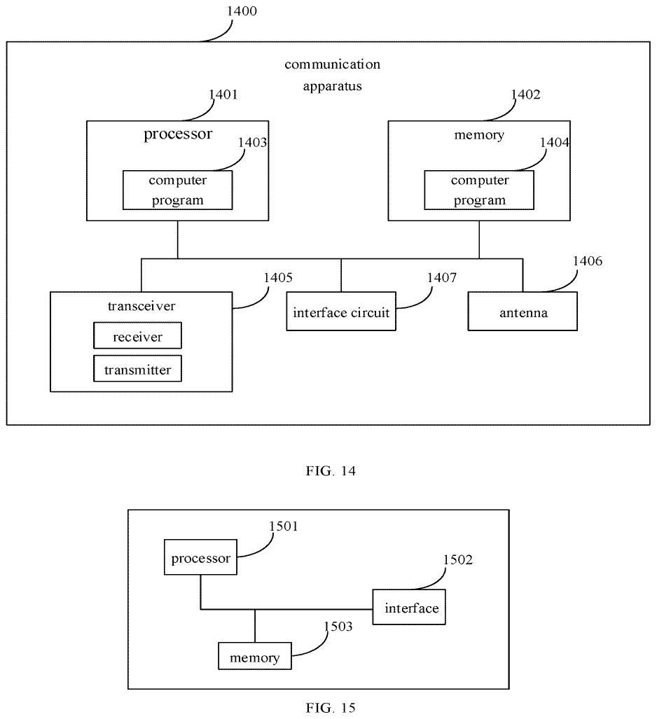

FIG. 12 is a schematic diagram of a communication apparatus according to an embodiment.

FIG. 15 is a schematic diagram of a chip according to an embodiment.

### DETAILED DESCRIPTION

Reference will now be made in detail to embodiments, examples of which are illustrated in the accompanying drawings. When the following description refers to the accompanying drawings, unless otherwise indicated, the same numerals in different accompanying drawings represent the same or similar elements. The implementations described in the following embodiments do not represent all implementations consistent with the disclosure. Instead, those implementations are merely examples of apparatuses and methods consistent with some aspects of the disclosure as detailed in the appended claims.

The terms used in the embodiments of the disclosure are only for the purpose of describing specific embodiments, and are not intended to limit the disclosure. The singular forms of “a” and “the” used in the embodiments and the attached claims of the disclosure are also intended to include plural forms, unless the context clearly indicates other meanings. It is understandable that the term “and/or” as used herein refers to and includes any or all possible combinations of one or more associated listed items.

It is understandable that although the terms “first”, “second” and “third” may be used in the embodiments of the disclosure to describe various types of information, the information should not be limited to these terms. These terms are only used to distinguish the same type of information from each other. For example, without departing from the scope of the embodiments of the disclosure, the first information may also be referred to as the second information, and similarly, the second information may also be referred to as the first information. Depending on the context, the term “if” as used herein may be interpreted as “when”, “while” or “in response to determining”.

The embodiments of the disclosure will be described in detail below. Examples of the embodiments are shown in the accompanying drawings, where the same or similar reference numerals denote the same or similar elements throughout. The embodiments described below with reference to the accompanying drawings are illustrative and are intended to explain the disclosure, but shall not be construed as limiting the disclosure.

For a better understanding of a communication method disclosed in the embodiments of the disclosure, a communication system to which the embodiments of the disclosure are applicable is first described below.

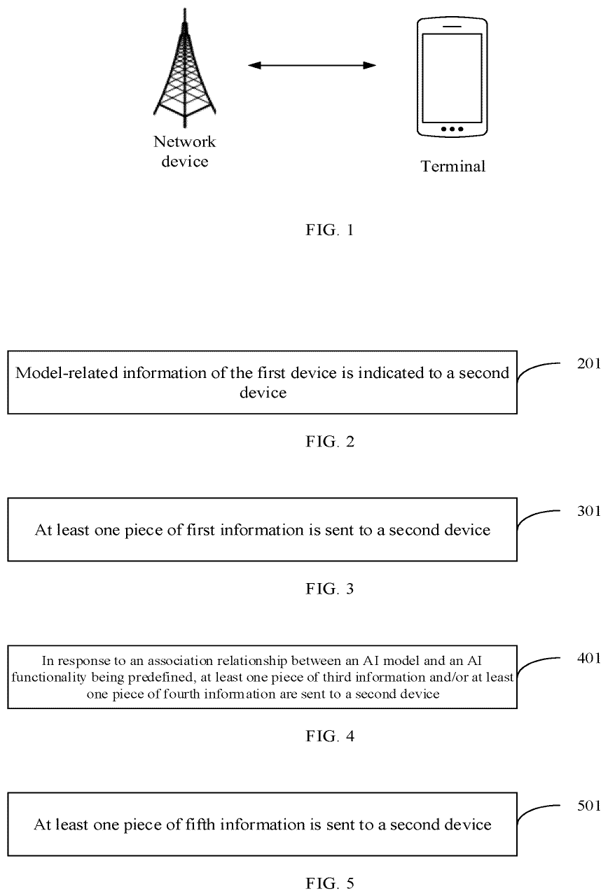

Please refer to FIG. 1, which is a schematic diagram of a communication system according to an embodiment. The communication system may include, but is not limited to, at least one first device and at least one second device. The first device may be a device on which one or more AI models are deployed, and the second device may be a device that needs to perform

AI model-related interactions with the first device. In some embodiments, the first device may be a terminal or a network device, and the second device may be a terminal or a network device. The number and form of devices shown in FIG. 1 are for illustration only and do not constitute a limitation on the embodiments of the disclosure. In application, the communication system may include one or more first devices, or one or more second devices. The communication system shown in FIG. 1 takes an example where including one first device (which is a terminal) and one second device (which is a network device).

It should be noted that the technical solutions of the embodiments of the disclosure can be applied to various communication systems, for example, a long term evolution (LTE) system, a 5th generation (5G) mobile communication system, a 5G new radio (NR) system, or other future new-type mobile communication systems, etc.

The terminal in the embodiments of the disclosure may be an entity on the user side for receiving or transmitting signals, such as a mobile phone. The terminal may also be referred to as a terminal, a terminal equipment, a mobile station (MS), a mobile terminal (MT), etc. The terminal may be a vehicle with communication functions, an intelligent vehicle, a mobile phone, a wearable device, a tablet computer (Pad), a computer with wireless transceiving function, a virtual reality (VR) terminal, an augmented reality (AR) terminal, a wireless terminal in industrial control, a wireless terminal in self-driving, a wireless terminal in remote medical surgery, a wireless terminal in a smart grid, a wireless terminal in transportation safety, a wireless terminal in a smart city, a wireless terminal in a smart home, and so on. The embodiments of the disclosure do not limit the specific technology and specific device form adopted by the terminal.

The network device in the embodiments of the disclosure may be an entity on the network side for transmitting or receiving signals. For example, the network device may be an evolved nodeB (eNB), a transmission reception point (TRP), a radio remote head (RRH), a next generation nodeB (gNB) in an NR system, a base station in other future mobile communication systems, or an access node in a wireless fidelity (Wi-Fi) system, etc. The embodiments of the disclosure do not limit the specific technology and specific device form adopted by the base station. The base station provided in the embodiments of the disclosure may be composed of a central unit (CU) and a distributed unit (DU), where the CU may also be called a control unit. The CU-DU structure may split protocol layers of the base station (e.g., the protocol layers of the base station), with the functions of some protocol layers placed in the CU for centralized control, and the functions of the remaining part or all of the protocol layers distributed in the DU, which is centrally controlled by the CU.

It may be understood that the communication system described in the embodiments of the disclosure is for the purpose of explaining the technical solutions of the embodiments of the disclosure more clearly, and does not constitute a limitation on the technical solutions provided by the embodiments of the disclosure. Those of ordinary skill in the art know that with the evolution of system architecture and emergences of new business scenarios, the technical solutions provided by the embodiments of the disclosure are also applicable to similar technical problems.

In addition, to facilitate the understanding of the embodiments of the disclosure, the following notes are provided.

First, in the disclosure, where there is no contradiction, each step in any implementation or embodiment may be implemented as an independent embodiment, and the steps may be combined arbitrarily. For example, a solution obtained by removing some steps from a certain implementation or embodiment may also be implemented as an independent embodiment; the order of steps in a certain implementation or embodiment may be exchanged arbitrarily; in addition, optional modes or optional examples in a certain implementation or embodiment may be combined arbitrarily. Furthermore, different implementations or embodiments may be combined arbitrarily. For instance, some or all steps of different implementations or embodiments may be combined arbitrarily, and a certain implementation or embodiment may be combined arbitrarily with optional modes or optional examples of other implementations or embodiments.

Second, regarding the expressions in the disclosure such as “A or B”, “A and/or B”, “at least one of A or B”, “A in one case and B in another case”, and “responding to case A and responding to case B”, they may include at least one of the following solutions depending on the situation: executing A independently of B, that is, A in some implementations; executing B independently of A, that is, B in some implementations; executing A and B selectively, that is, selecting to execute either A or B in some implementations; executing both A and B, that is, A and B in some implementations.

Third, each element, each row, or each column in the tables involved in the disclosure may be implemented as an independent embodiment, and combinations of any elements, any rows, or any columns may also be implemented as independent embodiments.

Fourth, in some implementations or embodiments, expressions in the disclosure such as “including A”, “comprising A”, “indicating A”, and “carrying A” may be interpreted as directly carrying A, or alternatively as indirectly indicating A.

Fifth, in some implementations or embodiments, expressions in the disclosure such as “in response to . . . ”, “in a case of . . . ”, “when . . . ”, “at the time of . . . ”, “if . . . ”, and “in an event that . . . ” may be replaced with each other.

FIG. 2 is a schematic flowchart of a communication method according to an embodiment of the disclosure. The communication method is performed by a first device. As shown in FIG. 2, the communication method may include the following step(s).

At step 201: model-related information of the first device is indicated to a second device.

In some embodiments, the first device may be a device on which one or more models (such as AI models) are deployed or stored, and the second device may be a device that needs to perform AI model-related interactions with the first device. For example, the second device may be a device that needs to manage (e.g., monitor, activate, switch) the one or more AI models in the first device. In some embodiments, the first device may be a terminal or a network device, and the second device may be a terminal or a network device.

In some embodiments, the model-related information may include at least one of: one or more AI models supported by the first device;
one or more AI functionalities associated with the one or more AI models supported by the first device;
one or more AI functionalities supported by the first device; or
one or more AI models associated with the one or more AI functionalities supported by the first device.

In some embodiments, the aforementioned “one or more AI models supported by the first device” may be understood as: one or more AI models deployed in the first device, and/or, one or more AI models stored in the first device.

The following is an introduction to the “AI model” in the embodiments of the disclosure.

In some embodiments, an AI model may be configured to implement one or more AI functionalities under at least one specific configuration. In some embodiments, the at least one specific configuration may include, for example: a specific beam configuration or a specific reference signal configuration, and the one or more AI functionalities may include, for example: channel state information (CSI) enhancement, CSI compression, time-domain CSI prediction, AI-based spatial beam prediction, AI-based positioning, and the like. Additionally, in some embodiments, there is an association relationship between the AI model and the one or more AI functionalities implemented by the AI model.

For example, assuming that for “AI-based spatial beam prediction”, two AI functionalities are defined, namely AI functionality 1 and AI functionality 2, which correspond to different beam configurations respectively. AI functionality 1 corresponds to beam configuration 1, and AI functionality 2 corresponds to beam configuration 2. Then, AI functionality 1 may be understood as: implementing the AI-based spatial beam prediction under beam configuration 1; AI functionality 2 may be understood as: implementing the AI-based spatial beam prediction under beam configuration 2. In this case, in a case where AI model 1 is defined to implement AI functionality 1, and AI model 2 is defined to implement AI functionality 2, then it is considered that there is an association relationship between AI model 1 and AI functionality 1, and there is an association relationship between AI model 2 and AI functionality 2.

In other embodiments, different AI models may also be configured to implement an AI functionality under a same configuration in different application scenarios.

For example, assuming that for “AI-based spatial beam prediction”, two AI functionalities are defined, namely AI functionality 1 and AI functionality 2, which correspond to different beam configurations respectively. AI functionality 1 corresponds to beam configuration 1, and AI functionality 2 corresponds to beam configuration 2. Then, two AI models may be defined for AI functionality 1, for example, AI model 3 is configured to implement AI functionality 1 in a low-speed scenario, and AI model 4 is configured to implement AI functionality 1 in a high-speed scenario. Similarly, two AI models may also be defined for AI functionality 2, for example, AI model 5 is configured to implement AI functionality 2 in a low-speed scenario, and AI model 6 is configured to implement AI functionality 2 in a high-speed scenario. In this case, it is considered that there are association relationships between AI functionality 1 and AI model 3 as well as AI model 4, and there are association relationships between AI functionality 2 and AI model 5 as well as AI model 6.

In some embodiments, the aforementioned “the association relationship between an AI model and an AI functionality” may be a one-to-one association relationship, a one-to-many association relationship, or a many-to-one association relationship.

It should be noted that the aforementioned “AI model” is only an exemplary name, and it may also be a machine learning (ML) model or other models with similar functions, which is not limited in the disclosure.

Further, in some embodiments, the “one or more AI functionalities associated respectively with the one or more AI models supported by the first device” in the model-related information may be understood as: one or more AI functionalities respectively implemented by the one or more AI models supported by the first device.

In some embodiments, the “one or more AI functionalities supported by the first device” in the model-related information may be understood as: one or more AI functionalities respectively implemented by the one or more AI models supported by the first device.

In some embodiments, the “one or more AI models associated with the one or more AI functionalities supported by the first device” in the model-related information may be understood as: one or more AI models supported by the first device that may implement the one or more AI functionalities supported by the first device.

It may be known from the foregoing content that the model-related information may reflect the association relationships between the one or more AI models supported by the first device and the one or more AI functionalities supported by the first device. Therefore, in some embodiments, when the first device indicates the model-related information of the first device to the second device, the second device may determine, based on the model-related information indicated by the first device, the association relationships between the one or more AI models supported by the first device and the one or more AI functionalities supported by the first device, and further determine which AI functionalities each AI model supported by the first device is configured to implement. This enables the second device's understanding for the AI model(s) on the first device to be consistent with an actual situation of the AI model(s) on the first device. That is, the understanding of the AI model(s) on the first device is unified between the first device and the second device, so that the second device may successfully manage the AI model(s) on the first device subsequently.

In some embodiments, the model-related information may further include one or more application scenarios of the one or more AI models supported by the first device. Thus, when the first device indicates the model-related information of the first device to the second device, the second device may know the one or more application scenarios of the one or more AI models supported by the first device, so that the second device may accurately manage the AI model(s) on the first device based on the application scenario(s) of the AI model(s) subsequently.

In some embodiments, the model-related information may be indicated to the second device in a case where the first device needs to perform model identification with the second device. In some embodiments, the aforementioned “case where the first device needs to perform the model identification with the second device” may include: a case where the second device indicates the first device to perform the model identification, or a case where the first device meets a trigger condition for the model identification. In some embodiments, the trigger condition may be preset.

In some embodiments, in a case where the first device indicates the model-related information of the first device to the second device, the first device may indicate the aforementioned model-related information to the second device based on a predefined “association relationship between an AI model and an AI functionality”. For the relevant introduction of the “association relationship between the AI model and the AI functionality”, reference may be made to the foregoing description.

In summary, according to the communication method provided by the embodiments of disclosure, the first device indicates the model-related information of the first device to the second device. The model-related information includes at least one of the following: one or more AI models supported by the first device; one or more AI functionalities associated with the one or more AI models supported by the first device; one or more AI functionalities supported by the first device; or one or more AI models associated with the one or more AI functionalities supported by the first device. Therefore, the model-related information may reflect the one or more association relationships between the one or more AI models supported by the first device and the one or more AI functionalities supported by the first device. By the first device sending the model-related information of the first device to the second device, the second device may determine, based on the model-related information indicated by the first device, which AI functionalities each AI model supported by the first device is configured to implement. This enables the second device's understanding for the AI model(s) on the first device to be consistent with an actual situation of the AI model(s) on the first device. The understanding of the AI model(s) on the first device is unified between the first device and the second device, so that the second device may successfully manage the AI model(s) on the first device subsequently, improving a stability of AI model management.

FIG. 3 is a schematic flowchart of a communication method according to an embodiment of the disclosure. The method is performed by a first device. As shown in FIG. 3, the communication method may include the following step(s).

At step 301: at least one piece of first information is sent to a second device.

In some embodiments, the at least one piece of first information may indicate one or more AI functionalities supported by the first device, and different pieces of first information may indicate different AI functionalities supported by the first device. In some embodiments, the first device may indicate an AI functionality supported by the first device by including a name and/or an identifier (ID) of the AI functionality supported by the first device in a piece of first information. In some embodiments, the name or ID of the AI functionality supported by the first device may be preset. For example, the name or ID of the AI functionality supported by the first device may be set independently by the first device, or may be determined by the second device and then indicated to the first device.

In some embodiments, a piece of first information may further include at least one piece of second information. In some embodiments, the at least one piece of second information included in the piece of first information may indicate one or more AI models supported by the first device and associated with an AI functionality indicated by the piece of first information. In other words, the at least one piece of second information included in the piece of first information may indicate one or more AI models supported by the first device for implementing the AI functionality indicated by the piece of first information. Different pieces of second information included in the piece of first information indicate different AI models. In some embodiments, the first device may indicate the AI model by including the name and/or ID of the AI model in second information. In some embodiments, the name or ID of the AI model may be preset. For example, the name or ID of the AI model may be set independently by the first device, or may be determined by the second device and then indicated to the first device.

For example, the following is an illustrative example of the format of first information. In some embodiments, assuming that for “AI-based spatial beam prediction”, two AI functionalities are defined, namely AI functionality 1 and AI functionality 2, which correspond to different beam configurations respectively. AI functionality 1 corresponds to beam configuration 1, and AI functionality 2 corresponds to beam configuration 2. In addition, two AI models are defined for AI functionality 1, for example, AI model x defined is configured to implement AI functionality 1 in a low-speed scenario, and AI model y defined is configured to implement AI functionality 1 in a high-speed scenario. Two AI models are defined for AI functionality 2, for example, AI model m defined is configured to implement AI functionality 2 in a low-speed scenario, and AI model n defined is configured to implement AI functionality 2 in a high-speed scenario. Then it may be known that: there are association relationships between AI functionality 1 and AI model x as well as AI model y, and there are association relationships between AI functionality 2 and AI model as well as AI model n. In this case, when the AI functionalities supported by the first device include AI functionality 1 and AI functionality 2, the format of the first information may be:

Support of functionality 1
{ support of AI model x;
Support of AI model y:
}

In some embodiments, the format of the first information may be:

Support of functionality 2
{ support of AI model m;
Support of AI model n:
}

In some embodiments, pieces of second information included in different pieces of first information may be the same or different. In some embodiments, when one AI model may implement a plurality of functionalities, the pieces of second information included in pieces of first information indicating the plurality of functionalities may be the same. For example, assuming the first device supports AI model m, and this AI model m may support both AI functionality 1 and AI functionality 2, the format of the first information indicating AI functionality 1 may be:

Support of functionality 1
{ support of AI model m;
}

The format of the first information indicating AI functionality 2 may be:

Support of functionality 2
{ support of AI model m;
}

In some embodiments, it should be noted that the first information may essentially be understood as information obtained after including model identification information in functionality identification information. In some embodiments, the functionality identification information may be information transmitted during a functionality identification process. For example, when the first device intends to perform functionality identification with the second device, the first device may send functionality identification information to the second device, and the functionality identification information may indicate the one or more AI functionalities supported by the first device. In some embodiments, the model identification information may be information transmitted during a model identification process. For example, when the first device intends to perform model identification with the second device, the first device may send model identification information to the second device, and the model identification information may indicate the one or more AI model supported by the first device. On this basis, in some embodiments, the method for composing the first information may be: composing the at least one piece of first information by adding associated model identification information for each AI functionality indicated by the original functionality identification information in the original functionality identification information. In some embodiments, when the first device composes the at least one piece of first information in the aforementioned method, the AI functionality and AI model supported by the first device that have the association relationship with each other are included in the same piece of first information. Thus, after the first device sends the at least one piece of first information to the second device, the second device may determine, based on received first information, one or more association relationships between one or more AI functionalities supported by the first device and one or more AI models supported by the first device (for example, determine that there is the association relationship between the AI functionality and the AI model included in the same piece of first information). This enables the second device's understanding for the AI model(s) on the first device to be consistent with an actual situation of the AI model(s) on the first device. The understanding of the AI model(s) on the first device is thus unified between the first device and the second device, so that the second device may successfully manage the AI model(s) on the first device subsequently.

In some embodiments, the first information may be sent by the first device to the second device via radio resource control (RRC) information and/or medium access control (MAC) layer information.

In summary, according to the communication method provided by the embodiment of the disclosure, the first device sends at least one piece of first information to the second device, and the at least one piece of first information may reflect the one or more association relationships between the one or more AI functionalities supported by the first device and the one or more AI models supported by the first device. After receiving the at least one piece of first information sent by the first device, the second device may determine, based on the at least one piece of first information, which AI functionalities each AI model supported by the first device is configured to implement. This enables the second device's understanding for the AI model(s) on the first device to be consistent with an actual situation of the AI model(s) on the first device. The understanding of the AI model(s) on the first device is thus unified between the first device and the second device, ensures that the second device may successfully manage the AI model(s) on the first device subsequently, and improves the stability of AI model management.

FIG. 4 is a schematic flowchart of a communication method according to an embodiment of the disclosure. The method is performed by a first device. As shown in FIG. 4, the communication method may include the following step(s).

At step 401: in response to an association relationship between an AI model and an AI functionality being predefined, at least one piece of third information and/or at least one piece of fourth information are sent to a second device.

In some embodiments, the aforementioned “association relationship between the AI model and the AI functionality being predefined” may be understood as: both the first device and the second device have pre-known the association relationship between the AI model and the AI functionality. For example, the “association relationship between the AI model and the AI functionality being predefined” may include: the association relationship between the AI model and the AI functionality being predefined by a protocol, or the association relationship between the AI model and the AI functionality being indicated by the first device to the second device, or the association relationship between the AI model and the AI functionality being indicated by the second device to the first device.

In some embodiments, the at least one piece of third information may indicate one or more AI functionalities supported by the first device, and the at least one piece of fourth information indicates one or more AI models supported by the first device. Different pieces of third information may indicate different AI functionalities supported by the first device, and different pieces of fourth information may indicate different AI models supported by the first device.

In some embodiments, when the association relationship between the AI model and the AI functionality is predefined, it means that both the first device and the second device are aware of which AI models are configured to implement which AI functionalities. On this basis, the first device does not need to further indicate to the second device the association relationship(s) between the one or more AI models and the one or more AI functionalities supported by the first device, but only needs to indicate to the second device the one or more AI models supported by the first device and/or the one or more AI functionalities supported by the first device, thereby enabling the second device to know which AI models in the first device are configured to implement which AI functionalities.

In some embodiments, when the first device indicates to the second device the one or more AI models supported by the first device (i.e., when the first device sends the at least one piece of fourth information to the second device), since the second device is already aware of the association relationship between the AI model and the AI functionality, after learning, based on an indication from the first device, which AI models the first device supports, the second device may directly infer, based on the association relationship between the AI model and the AI functionality, which specific AI functionalities each AI model supported by the first device is configured to implement.

For example, assume association relationships between AI models and AI functionalities is as follows: AI model 1 is associated with AI functionality 1 (i.e., AI model 1 may be configured to implement AI functionality 1), AI model 2 is associated with AI functionality 2 (i.e., AI model 2 may be configured to implement AI functionality 2), and AI model 3 is associated with AI functionality 3 (i.e., AI model 3 may be configured to implement AI functionality 3). In this case, when AI models supported by the first device are AI model 1 and AI model 2, and AI functionalities supported by the first device are AI functionality 1 and AI functionality 2, the first device may send at least one piece of fourth information to the second device to indicate that the AI models supported by the first device are AI model 1 and AI model 2. Moreover, when the second device learns, based on the at least one piece of fourth information sent by the first device, that the AI models supported by the first device are AI model 1 and AI model 2, the second device may determine, based on the association relationships between the AI models and the AI functionalities, that AI model 1 is configured to implement AI functionality 1 and AI model 2 is configured to implement AI functionality 2. Thus, the second device may infer that the AI functionalities supported by the first device are AI functionality 1 and AI functionality 2, with AI functionality 1 implemented by AI model 1 and AI functionality 2 implemented by AI model 2, thereby aligning the second device's understanding of the AI models on the first device with an actual situation of the AI models on the first device.

Similarly, in some embodiments, when the first device indicates to the second device the one or more AI functionalities supported by the first device (i.e., when the first device sends the at least one piece of third information to the second device), since the second device is already aware of the association relationship between the AI model and the AI functionality, after learning, based on an indication from the first device, which AI functionalities the first device supports, the second device may first infer which AI models the first device supports based on the association relationship between the AI model and the AI functionality, and then further infer which specific AI functionalities each AI model supported by the first device is configured to implement.

However, it should be noted that in some embodiments, the step of “the first device indicating to the second device the one or more AI functionalities supported by the first device (i.e., the first device sending the at least one piece of third information to the second device)” has an execution precondition: “the association relationship between the AI model and the AI functionality being a one-to-one association relationship”. Specifically, when the association relationship between the AI model and the AI functionality is not the one-to-one association relationship, for example, when AI functionality 1 is associated with both AI model 1 and AI model 2 (i.e., both AI model 1 and AI model 2 may implement AI functionality 1), then the first device may support AI functionality 1 as long as the first device supports either AI model 1 or AI model 2. On this basis, when the first device indicates to the second device that the AI functionality the first device supports is AI functionality 1, the second device cannot determine whether the first device specifically supports AI model 1, AI model 2, or both AI model 1 and AI model 2, which results in the second device being unable to clearly understand the AI model(s) on the first device. Based on this, the step of “sending at least one piece of third information to the second device” needs to be executed under the precondition that “the association relationship between the AI model and the AI functionality being the one-to-one association relationship”, so as to ensure an achievement of a purpose of “indicating to the second device the association relationship(s) between the one or more AI models and the one or more AI functionalities supported by the first device”.

For example, assume the association relationship between the AI model and the AI functionality being the one-to-one association relationship: AI model 1 is associated with AI functionality 1 (i.e., AI model 1 may be configured to implement AI functionality 1), AI model 2 is associated with AI functionality 2 (i.e., AI model 2 may be configured to implement AI functionality 2), and AI model 3 is associated with AI functionality 3 (i.e., AI model 3 may be configured to implement AI functionality 3). In this case, when AI functionalities supported by the first device are AI functionality 1 and AI functionality 2, and AI models supported by the first device are AI model 1 and AI model 2, the first device may send at least one piece of third information to the second device to indicate that the AI functionalities supported by the first device are AI functionality 1 and AI functionality 2. Moreover, when the second device learns, based on the at least one piece of third information sent by the first device, that the AI functionalities supported by the first device are AI functionality 1 and AI functionality 2, the second device may determine, based on the association relationships between AI models and AI functionalities, that AI functionality 1 is uniquely implemented by AI model 1 and AI functionality 2 is uniquely implemented by AI model 2. Thus, the second device may infer that the AI models supported by the first device are AI model 1 and AI model 2, with AI model 1 configured to implement AI functionality 1 and AI model 2 configured to implement AI functionality 2, thereby aligning the second device's understanding of the AI models on the first device with an actual situation of the AI models on the first device.

In some embodiments, the at least one piece of third information and/or the at least one piece of fourth information may be sent by the first device to the second device via RRC information and/or MAC layer information.

In summary, according to the communication method provided by the embodiment of the disclosure, in response to the association relationship between the AI model and the AI functionality being predefined, the first device sends at least one piece of third information and/or at least one piece of fourth information to the second device. The at least one piece of third information indicates the one or more AI functionalities supported by the first device, and the at least one piece of fourth information indicates the one or more AI models supported by the first device. Under the premise that the association relationship between the AI model and the AI functionality is predefined, the at least one piece of third information and/or the at least one piece of fourth information may reflect the association relationship(s) between the one or more AI models supported by the first device and the one or more AI functionalities supported by the first device. After receiving the at least one piece of third information and/or the at least one piece of fourth information sent by the first device, the second device may determine, based on the at least one piece of third information and/or the at least one piece of fourth information, which AI functionalities each AI model supported by the first device is configured to implement. This enables the second device's understanding for the AI model(s) on the first device to be consistent with an actual situation of the AI model(s) on the first device, unifies the understanding of the AI model(s) on the first device between the first device and the second device, ensures that the second device may successfully manage the AI model(s) on the first device subsequently, and improves the stability of AI model management.

FIG. 5 is a schematic flowchart of a communication method according to an embodiment of the disclosure. The method is performed by a first device. As shown in FIG. 5, the communication method may include the following step(s).

At step 501: at least one piece of fifth information is sent to a second device.

In some embodiments, the at least one piece of fifth information may indicate one or more AI models supported by the first device, and different pieces of fifth information may indicate different AI models supported by the first device. In some embodiments, the first device may indicate the one or more AI models supported by the first device by including a name and/or an ID of an AI model supported by the first device in a piece of fifth information. In some embodiment, the name or the ID of the AI model supported by the first device may be preset, and relevant introductions about this part may refer to the above embodiments.

In some embodiments, a piece of fifth information may further include at least one piece of sixth information. In some embodiments, the at least one piece of sixth information included in the piece of fifth information may indicate one or more AI functionalities associated with an AI model indicated by the piece of fifth information. In other words, the at least one piece of sixth information included in the piece of fifth information may indicate the one or more AI functionalities that the AI model indicated by the piece of fifth information may implement, where different pieces of sixth information included in the piece of fifth information indicate different AI functionalities. In some embodiments, the first device may indicate an AI functionality by including a name and/or an ID of the AI functionality in a piece of sixth information. In some embodiments, the name or the ID of the AI functionality may be preset, and relevant introductions about this part may refer to the above embodiments.

For example, the following is an example of a format of fifth information. In some embodiments, it is assumed that for “AI-based spatial beam prediction”, two AI functionalities are defined, namely AI functionality 1 and AI functionality 2, which correspond to different beam configurations respectively. AI functionality 1 corresponds to beam configuration 1, and AI functionality 2 corresponds to beam configuration 2. AI model m is defined to implement AI functionality 1, and AI model n is defined to implement AI functionality 2. It may thus be known that there is an association relationship between AI model m and AI functionality 1, and there is an association relationship between AI model n and AI functionality 2. In this case, when AI models supported by the first device are AI model m and AI model n, the format of the fifth information may be:
Support of AI model m
{linked Functionality Functionality 1}

In some embodiments, the format of the fifth information may be:
Support of AI model n
{linked Functionality Functionality 2}

In some embodiments, it should be noted that in some embodiments, the fifth information may essentially be understood as information obtained after including functionality identification information in model identification information. In some embodiments, detailed introductions about functionality identification information and model identification can refer to the descriptions in the foregoing embodiments.

Based on the above descriptions, in some embodiments, the method for constructing the fifth information may be: constructing the at least one piece of fifth information by adding associated functionality identification information for each AI model indicated by original model identification information in the original model identification information. In some embodiments, when the first device constructs the at least one piece of fifth information in the above manner, the AI functionality and AI model supported by the first device that have the association relationship with each other are included in the same piece of fifth information. Thus, after the first device sends the at least one piece of fifth information to the second device, the second device may determine, based on received fifth information, one or more association relationships between one or more AI functionalities supported by the first device and one or more AI models supported by the first device (for example, determine that there is the association relationship between the AI functionality and the AI model included in the same piece of fifth information). This enables the second device's understanding for the AI model(s) on the first device to be consistent with an actual situation of the AI model(s) on the first device, thereby unifying the understanding of the AI model(s) on the first device between the first device and the second device, ensuring that the second device may successfully manage the AI model(s) on the first device subsequently, and improving the stability of AI model management.

In some embodiments, the at least one or fifth information may be sent by the first device to the second device via RRC information and/or MAC layer information.

In summary, according to the communication method provided by the embodiment of the disclosure, the first device sends at least one piece of fifth information to the second device, and the at least one piece of fifth information may reflect the one or more association relationships between the one or more AI functionalities supported by the first device and the one or more AI models supported by the first device. After receiving the at least one piece of fifth information sent by the first device, the second device may determine, based on the at least one piece of fifth information, which AI functionalities each AI model supported by the first device is configured to implement. This enables the second device's understanding for the AI model(s) on the first device to be consistent with an actual situation of the AI model(s) on the first device, unifies the understanding of the AI model(s) on the first device between the first device and the second device, ensures that the second device can successfully manage the AI models on the first device subsequently, and improves the stability of AI model management.

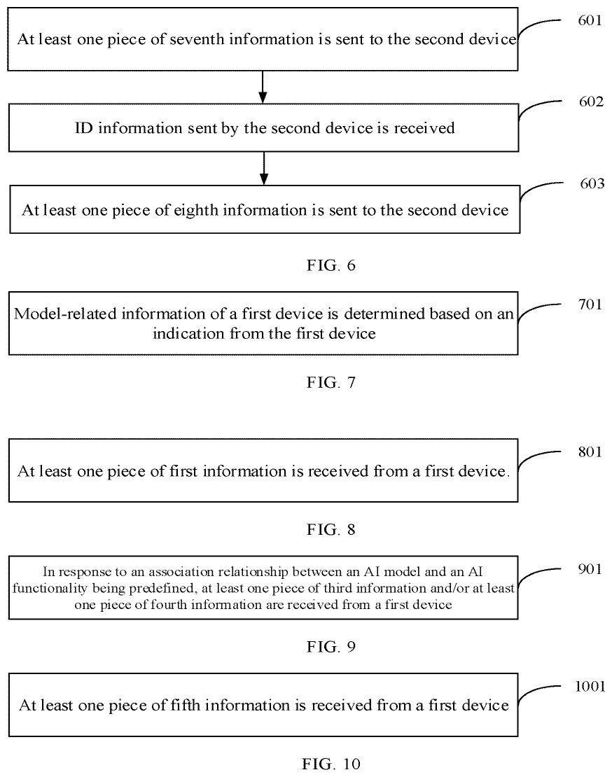

FIG. 6 is a schematic flowchart of a communication method according to an embodiment of the disclosure. The method is performed by the first device. As shown in FIG. 6, the communication method may include the following step(s).

At step 601: at least one piece of seventh information is sent to the second device.

In some embodiments, the at least one piece of seventh information may indicate one or more AI functionalities supported by the first device, and different pieces of seventh information may indicate different AI functionalities supported by the first device. In some embodiments, the first device may indicate the one or more AI functionalities supported by the first device by including name(s) of the one or more AI functionalities supported by the first device in the at least one piece of seventh information.

For example, assuming AI functionalities supported by the first device are AI Functionality x and AI Functionality y, a piece of seventh information may be “Support of AI Functionality x”; or, a piece of seventh information may be “Support of AI Functionality y”.

In some embodiments, seventh information may be the aforementioned functionality identification information, and in some embodiments, step 601 may be considered as the functionality identification process of the first device.

In some embodiments, the first device may send the at least one piece of seventh information to the second device via RRC information and/or MAC layer information.

At step 602, ID information sent by the second device is received.

In some embodiments, the ID information may include: one or more IDs assigned respectively by the second device to the one or more AI functionalities supported by the first device.

In some embodiments, when the second device receives the at least one piece of seventh information sent by the first device, the second device may first perform a check (e.g., cyclic redundancy check (CRC)) on the at least one piece of seventh information. When the check passes, the second device confirms successful reception (or is referred to as determining that the functionality identification process of the first device is successful), and then the second device may assign respectively the one or more IDs to the one or more AI functionalities supported by the first device (as indicated by the at least one piece of seventh information) to obtain the ID information, and send the ID information to the first device.

For example, when the at least one piece of seventh information sent by the first device indicates AI Functionality x and AI Functionality y, the second device may assign an ID “1” to AI Functionality x and assign an ID “2” to AI Functionality y, and send the ID information to the first device. The ID information may be, for example: AI functionality 1, AI functionality 2. Therefore, the first device may know from the ID information that the ID corresponding to AI Functionality x is AI functionality 1, and the ID corresponding to AI Functionality y is AI functionality 2.

At step 603: at least one piece of eighth information is sent to the second device.

In some embodiments, the at least one piece of eighth information may indicate one or more AI models supported by the first device, and different pieces of eighth information may indicate different AI models supported by the first device. In some embodiments, the first device may indicate an AI model supported by the first device by including a names and/or an ID of the AI model supported by the first device in a piece of eighth information. In some embodiments, the name or the ID of the AI model supported by the first device may be preset, and relevant introductions about this part may refer to the above embodiments.

In some embodiments, a piece of eighth information may further include at least one piece of ID information. In some embodiments, the at least one piece of ID information included in the piece of eighth information may be: one or more IDs respectively corresponding to one or more AI functionalities associated with an AI model indicated by the piece of eighth information.

For example, assuming AI models supported by the first device are AI model m and AI model n, where AI model m is associated with AI Functionality x (i.e., AI model m is configured to implement AI Functionality x) and AI model n is associated with AI Functionality y (i.e., AI model n is configured to implement AI Functionality y), a format of eighth information may be:

Support of AI model m
{Linked AI functionality #1
}

In some embodiments, the format of the eighth information may be:

Support of AI model n
{Linked AI functionality #2
}

In some embodiments, the at least one piece of eighth information may be sent by the first device to the second device via RRC information and/or MAC layer information.

In summary, according to the communication method provided by the embodiment of the disclosure, the first device sends at least one piece of eighth information to the second device, and the at least one piece of eighth information may reflect one or more association relationships between the one or more AI models supported by the first device and the one or more Al functionalities supported by the first device. After receiving the at least one piece of eighth information sent by the first device, the second device may determine, based on the at least one piece of eighth information, which AI functionalities each AI model supported by the first device is configured to implement. This enables the second device's understanding for the AI model(s) on the first device to be consistent with an actual situation of the AI model(s) on the first device, unifies the understanding of the AI model(s) on the first device between the first device and the second device, ensures that the second device can successfully manage the AI models on the first device subsequently, and improves the stability of AI model management.

FIG. 7 is a schematic flowchart of a communication method according to an embodiment of the disclosure. The method is performed by a second device. As shown in FIG. 7, the communication method may include the following step(s).

At step 701: model-related information of a first device is determined based on an indication from the first device.

For a detailed introduction to step 701, reference may be made to the descriptions in the above embodiments.

In summary, according to the communication method provided by the embodiment of the disclosure, the first device indicates the model-related information of the first device to the second device. The model-related information includes at least one of the following: one or more AI models supported by the first device; one or more AI functionalities associated with the one or more AI models supported by the first device; one or more AI functionalities supported by the first device; or one or more AI models associated with the one or more AI functionalities supported by the first device. Therefore, the model-related information may reflect one or more association relationships between the one or more AI models supported by the first device and the one or more AI functionalities supported by the first device. By the first device sending the model-related information of the first device to the second device, the second device may determine, based on the model-related information indicated by the first device, which AI functionalities each AI model supported by the first device is configured to implement. This enables the second device's understanding for the AI model(s) on the first device to be consistent with an actual situation of the AI model(s) on the first device. The understanding of the AI model(s) on the first device is unified between the first device and the second device, so that the second device may successfully manage the AI model(s) on the first device subsequently, improving a stability of AI model management.

FIG. 8 is a schematic flowchart of a communication method according to an embodiment of the disclosure. The method is performed by a second device. As shown in FIG. 8, the communication method may include the following step(s).

At step 801, at least one piece of first information is received from a first device.

For a detailed introduction to step 801, reference may be made to the descriptions in the above embodiments.

In summary, according to the communication method provided by the embodiment of the disclosure, the first device sends at least one piece of first information to the second device, and the at least one piece of first information may reflect the one or more association relationships between the one or more AI functionalities supported by the first device and the one or more AI models supported by the first device. After receiving the at least one piece of first information sent by the first device, the second device may determine, based on the at least one piece of first information, which AI functionalities each AI model supported by the first device is configured to implement. This enables the second device's understanding for the AI model(s) on the first device to be consistent with an actual situation of the AI model(s) on the first device. The understanding of the AI model(s) on the first device is thus unified between the first device and the second device, ensures that the second device may successfully manage the AI model(s) on the first device subsequently, and improves the stability of AI model management.

FIG. 9 is a schematic flowchart of a communication method according to an embodiment of the disclosure. The method is performed by a second device. As shown in FIG. 9, the communication method may include the following step(s).

At step 901, in response to an association relationship between an AI model and an AI functionality being predefined, at least one piece of third information and/or at least one piece of fourth information are received from a first device.

For a detailed introduction to step 901, reference may be made to the descriptions in the above embodiments.

In summary, according to the communication method provided by the embodiment of the disclosure, in response to the association relationship between the AI model and the AI functionality being predefined, the first device sends at least one piece of third information and/or at least one piece of fourth information to the second device. The at least one piece of third information indicates the one or more AI functionalities supported by the first device, and the at least one piece of fourth information indicates the one or more AI models supported by the first device. Under the premise that the association relationship between the AI model and the AI functionality is predefined, the at least one piece of third information and/or the at least one piece of fourth information may reflect the association relationship(s) between the one or more AI models supported by the first device and the one or more AI functionalities supported by the first device. After receiving the at least one piece of third information and/or the at least one piece of fourth information sent by the first device, the second device may determine, based on the at least one piece of third information and/or the at least one piece of fourth information, which AI functionalities each AI model supported by the first device is configured to implement. This enables the second device's understanding for the AI model(s) on the first device to be consistent with an actual situation of the AI model(s) on the first device, unifies the understanding of the AI model(s) on the first device between the first device and the second device, ensures that the second device may successfully manage the AI model(s) on the first device subsequently, and improves the stability of AI model management.

FIG. 10 is a schematic flowchart of a communication method according to an embodiment of the disclosure. The method is performed by a second device. As shown in FIG. 10, the communication method may include the following step(s).

At step 1001, at least one piece of fifth information is received from a first device.

For a detailed introduction to step 1001, reference may be made to the descriptions in the above embodiments.

In summary, according to the communication method provided by the embodiment of the disclosure, the first device sends at least one piece of fifth information to the second device, and the at least one piece of fifth information may reflect the one or more association relationships between the one or more AI functionalities supported by the first device and the one or more AI models supported by the first device. After receiving the at least one piece of fifth information sent by the first device, the second device may determine, based on the at least one piece of fifth information, which AI functionalities each AI model supported by the first device is configured to implement. This enables the second device's understanding for the AI model(s) on the first device to be consistent with an actual situation of the AI model(s) on the first device, unifies the understanding of the AI model(s) on the first device between the first device and the second device, ensures that the second device can successfully manage the AI models on the first device subsequently, and improves the stability of AI model management.

FIG. 11 is a schematic flowchart of a communication method according to an embodiment of the disclosure. The method is performed by a second device. As shown in FIG. 11, the communication method may include the following step(s).

At step 1101, at least one piece of seventh information is received from a first device.

At step 1102, ID information is sent to the first device.

At step 1103, at least one piece of eighth information is received from the first device.

For a detailed introduction to step 1101 to step 1103, reference may be made to the descriptions in the above embodiments.

In summary, according to the communication method provided by the embodiment of the disclosure, the first device sends at least one piece of eighth information to the second device, and the at least one piece of eighth information may reflect one or more association relationships between the one or more AI models supported by the first device and the one or more AI functionalities supported by the first device. After receiving the at least one piece of eighth information sent by the first device, the second device may determine, based on the at least one piece of eighth information, which AI functionalities each AI model supported by the first device is configured to implement. This enables the second device's understanding for the AI model(s) on the first device to be consistent with an actual situation of the AI model(s) on the first device, unifies the understanding of the AI model(s) on the first device between the first device and the second device, ensures that the second device can successfully manage the AI models on the first device subsequently, and improves the stability of AI model management.

FIG. 12 is a schematic diagram of a communication apparatus according to an embodiment of the disclosure. As shown in FIG. 12, the communication apparatus may include:
a transceiving module, configured to indicate model-related information of a first device to a second device.

The model-related information includes at least one of:
one or more AI models supported by the first device;
one or more AI functionalities associated with the one or more AI models supported by the first device;
one or more AI functionalities supported by the first device; or
one or more AI models associated with the one or more AI functionalities supported by the first device.

In summary, according to the communication apparatus provided by the embodiment of the disclosure, the first device indicates the model-related information of the first device to the second device. The model-related information includes at least one of the following: one or more AI models supported by the first device; one or more AI functionalities associated with the one or more AI models supported by the first device; one or more AI functionalities supported by the first device; or one or more AI models associated with the one or more AI functionalities supported by the first device. Therefore, the model-related information may reflect one or more association relationships between the one or more AI models supported by the first device and the one or more AI functionalities supported by the first device. By the first device sending the model-related information of the first device to the second device, the second device may determine, based on the model-related information indicated by the first device, which AI functionalities each AI model supported by the first device is configured to implement. This enables the second device's understanding for the AI model(s) on the first device to be consistent with an actual situation of the AI model(s) on the first device. The understanding of the AI model(s) on the first device is unified between the first device and the second device, so that the second device may successfully manage the AI model(s) on the first device subsequently, improving a stability of AI model management.

In some embodiments, the transceiving module is further configured to:
send at least one piece of first information to the second device. The at least one piece of first information indicates the one or more AI functionalities supported by the first device, and a piece of first information includes at least one piece of second information, in which the at least one piece of second information indicates one or more AI models supported by the first device and associated with an AI functionality indicated by the piece of first information.

In some embodiments, pieces of second information included in different pieces of first information are the same or different.

In some embodiments, the transceiving module is further configured to:
in response to an association relationship between an AI model and an AI functionality being predefined, send at least one piece of third information and/or at least one piece of fourth information to the second device;
in which at least one piece of third information indicates the one or more AI functionalities supported by the first device, and the at least one piece of fourth information indicates the one or more AI models supported by the first device.

In some embodiments, the transceiving module is further configured to:
in response to the association relationship between an AI model and an AI functionality being a one-to-one association relationship, send the at least one piece of third information to the second device.

In some embodiments, the transceiving module is further configured to:
send at least one piece of fifth information to the second device, in which the at least one piece of fifth information indicates the one or more AI models supported by the first device, and a piece of fifth information further includes at least one piece of sixth information, in which the at least one piece of sixth information indicates one or more AI functionalities associated with an AI model indicated by the piece of fifth information.

In some embodiments, the transceiving module is further configured to:
send at least one piece of seventh information to the second device, in which the at least one piece of seventh information indicates the one or more AI functionalities supported by the first device;
receive ID information sent by the second device, in which the ID information includes: one or more IDs assigned respectively by the second device to the one or more AI functionalities supported by the first device; and
send at least one piece of eighth information to the second device, in which the at least one piece of eighth information indicates the one or more AI models supported by the first device, and a piece of eighth information further includes at least one piece of ID information, in which the at least one piece of ID information includes: one or more IDs respectively corresponding to one or more AI functionalities associated with an AI model indicated by the piece of eighth information.

In some embodiments, the model-related information further includes: one or more application scenarios for the one or more AI models supported by the first device.

In some embodiments, the first device is a device deploying or storing the one or more AI models, and the second device is a device to manage the one or more AI models in the first device.

FIG. 13 is a schematic diagram of a communication apparatus according to an embodiment of the disclosure. As shown in FIG. 13, the communication apparatus may include:
a processing module, configured to determine model-related information of a first device based on an indication from the first device;
in which the model-related information includes at least one of:
one or more artificial intelligence (AI) models supported by the first device;
one or more AI functionalities associated with the one or more AI models supported by the first device;
one or more AI functionalities supported by the first device; or
one or more AI models associated with the one or more AI functionalities supported by the first device.

In summary, according to the communication apparatus provided by the embodiment of the disclosure, the first device indicates the model-related information of the first device to the second device. The model-related information includes at least one of the following: one or more AI models supported by the first device; one or more AI functionalities associated with the one or more AI models supported by the first device; one or more AI functionalities supported by the first device; or one or more AI models associated with the one or more AI functionalities supported by the first device. Therefore, the model-related information may reflect one or more association relationships between the one or more AI models supported by the first device and the one or more AI functionalities supported by the first device. By the first device sending the model-related information of the first device to the second device, the second device may determine, based on the model-related information indicated by the first device, which AI functionalities each AI model supported by the first device is configured to implement. This enables the second device's understanding for the AI model(s) on the first device to be consistent with an actual situation of the AI model(s) on the first device. The understanding of the AI model(s) on the first device is unified between the first device and the second device, so that the second device may successfully manage the AI model(s) on the first device subsequently, improving a stability of AI model management.

In some embodiments, the processing module is further configured to:
receive at least one piece of first information from the first device, in which the at least one piece of first information indicates the one or more AI functionalities supported by the first device, and a piece of first information includes at least one piece of second information, in which the at least one piece of second information indicates one or more AI models supported by the first device and associated with an AI functionality indicated by the piece of first information.

In some embodiments, pieces of second information included in different pieces of first information are the same or different.

In some embodiments, the processing module is further configured to:
in response to an association relationship between an AI model and an AI functionality being predefined, receive at least one piece of third information and/or at least one piece of fourth information from the first device;
in which the at least one piece of third information indicates the one or more AI functionalities supported by the first device, and the at least one piece of fourth information indicates the one or more AI models supported by the first device.

In some embodiments, the processing module is further configured to:
in response to the association relationship between an AI model and an AI functionality being a one-to-one association relationship, receive the at least one piece of third information from the first device.

In some embodiments, the processing module is further configured to:
receive at least one piece of fifth information from the first device, in which the at least one piece of fifth information indicates the one or more AI models supported by the first device, and a piece of fifth information further includes at least one piece of sixth information, in which the at least one piece of sixth information indicates one or more AI functionalities associated with an AI model indicated by the piece of fifth information.

In some embodiments, the processing module is further configured to:
receive at least one piece of seventh information from the first device, in which the at least one piece of seventh information indicates the one or more AI functionalities supported by the first device;
send ID information to the first device, in which the ID information includes: one or more IDs assigned respectively by the second device to the one or more AI functionalities supported by the first device; and
receive at least one piece of eighth information from the first device, in which the at least one piece of eighth information indicates the one or more AI models supported by the first device, and a piece of eighth information further includes at least one piece of ID information, in which the at least one piece of ID information includes: one or more IDs respectively corresponding to one or more AI functionalities associated with an AI model indicated by the piece of eighth information.

In some embodiments, the model-related information further includes: one or more application scenarios for the one or more AI models supported by the first device.

In some embodiments, the first device is a device deploying or storing the one or more AI models, and the second device is a device to manage the one or more AI models in the first device.

The following is an illustrative introduction to the communication method of the disclosure.

In some embodiments, in an AI-based deployment solution, models may be deployed on the terminal side, and the network side also needs to participate in the management of AI models. Therefore, the network side and the terminal side need to align relevant information of the AI models. Accordingly, the following process is defined in 3GPP: functionality identification, where the terminal needs to report one or more AI functionalities supported by the terminal.

Additionally, in 3GPP discussions, the following relationships are further defined.

One AI/ML feature may include one or more functionalities, and each functionality may be targeted at a specific application environment or scenario.

Here, AI/ML feature may be an AI/ML use case. For example, the AI/ML feature may be CSI compression, time-domain CSI prediction, or AI-based spatial beam prediction, etc.

One functionality may correspond to one or more AI models.

In some embodiments, model identification is defined in 3GPP discussions. A purpose of AI model identification is to unify the understanding of AI models between the network and the terminal. However, the specific process of model identification is unclear, and the relationship between model identification and functionality identification is also unclear.

In some embodiments, the disclosure provides a method for mapping functionalities and models, and a method for performing the model identification.

In some embodiments, (1) one or more functionalities associated with the AI model are determined. The AI model may be associated with one or more functionalities, and the AI model identification is performed based on the mapping relationship between the AI model and the functionalities.

In some embodiments, in response to the terminal needing to perform the model identification, the terminal needs to perform the functionality identification. Report information for the functionality identification includes the terminal's model identification information. For example, for AI-based spatial beam prediction, two functionalities are defined, which are respectively targeted at different beam configurations or different reference signal configurations. Two AI models are also defined for each of the two functionalities, where one AI model is configured for a high-speed scenario and the other is configured for a low-speed scenario. In this case, when the terminal reports functionalities and models, the terminal may report in the following manner:

Support of functionality 1
{ support of AI model x;
Support of AI model y;
}

Support of functionality 2
{ support of AI model m;
Support of AI model n;
}

In some embodiments, in response to one AI model being capable of implementing a plurality of functionalities, a plurality of functionality identifications also need to be performed during the process of AI model identification.

For example, when AI model m is able to support both functionality 1 and functionality 2, the model identification method in this case may be:

Support of functionality 1
{ support of AI model m;
}

Support of functionality 2
{ support of AI model m;
}

In some embodiments, one or more relationships between one or more functionalities and one or more AI models are predefined in advance. In response to the terminal needing to perform the model identification, the AI model identification may be directly performed at this time.

For example, a relationship between AI model m and functionality 1 is predefined in advance, and a relationship between AI model n and functionality 2 is predefined. In this case, when the terminal reports AI model m or AI model n, the network may know, via the predefined relationships, that AI model m may implement functionality 1 and AI model n may implement functionality 2. When one AI model may implement a plurality of functionalities in this case, a one-to-many mapping may be achieved when predefining the mapping relationship.

In some embodiments, in response to the terminal needing to perform the AI model identification, the terminal directly performs the model identification, and the model identification information in this case includes information about the implemented AI functionalities.

For example:
Support of AI model m
{linked Functionality Functionality #1}
Support of AI model n
{linked Functionality Functionality 2}

When one AI model may be mapped to a plurality of AI functionalities, a plurality of linked functionalities may be reported during the reporting process in this case.

In some embodiments, in response to the terminal needing to perform the AI model identification, the terminal needs to perform the functionality identification, and performs the model identification only after the functionality identification is successful.

For example:
The terminal sends information:
Support of Functionality x
Support of Functionality y
   The network confirms success and assigns corresponding IDs (functionality #1, functionality #2) to each functionality;
   The terminal performs the model identification and reports the corresponding functionalities:

Support of AI model m
{Linked functionality #1
}

Support of AI model n
{Linked functionality #2
}

In some embodiments, when the terminal reports functionality 1 and functionality 2 (which correspond to configuration 1 and configuration 2 respectively), this actually proves that the terminal may only use AI to operate under configuration 1 or configuration 2; the terminal does not support AI-based operations under other configurations.

Additionally, the network side also knows that the terminal operates using functionality 1 under configuration 1 and using functionality 2 under configuration 2. In this case, the network may also manage functionalities based on configuration information, such as activation and switching.

In some embodiments, the network side numbers or names AI models. For example, the terminal reports that the terminal supports AI model m and also reports that this AI model is used in high-speed situations. Moreover, the terminal reports 5 models in sequence. Then the network side may number these 5 models in sequence and inform the terminal of a numbering condition of the network side

In some embodiments, an indication of a corresponding functionality may be based on an ID or a name. Indications using only the ID or the name may be predefined. For example, configuration and specific function corresponding to functionality #1 are predefined in a protocol. Then the terminal reports based on its own support for the predefined content of the protocol. This method may be applied in (2), (3), and (5). Another method is that the protocol does not predefine each functionality, and the terminal reports its own support for one or more functionalities. In this case, the terminal may name the one or more functionalities itself, or the network side may name the one or more functionalities. When the network side is responsible for naming, some preset rules are needed to synchronize the understanding of the one or more functionalities between the network and the terminal. For example, when the terminal reports N functionalities in sequence in a signaling, the network side assigns N IDs or N names.

Please refer to FIG. 14, which is a schematic diagram of a communication apparatus 1400 provided in an embodiment of the disclosure. The communication apparatus 1400 may be a terminal, a network device, or a chip, chip system, or processor that supports the terminal to implement the above methods, or a chip, chip system, or processor that supports the network device to implement the above methods. The communication apparatus 1400 may be configured to implement the methods described in the above method embodiments. For details, reference may be made to the description in the above method embodiments.

The communication apparatus 1400 may include one or more processors 1401. The processor 1401 may be a general processor or a dedicated processor. For example, it may be a baseband processor or a central processing unit. The baseband processor may be used to process communication protocols and communication data, and the central processing unit may be used to control the communication apparatus (such as a network device, a baseband chip, a terminal, a terminal chip, a DU or a CU, etc.), execute computer programs, and process computer program data.

In some embodiments, the communication apparatus 1400 may further include one or more memories 1402, on which a computer program 1404 may be stored. The memory 1402 executes the computer program 1404 to enable the communication apparatus 1400 to perform the methods described in the above method embodiments. In some embodiments, data may also be stored in the memory 1402. The communication apparatus 1400 and the memory 1402 may be provided separately or integrated together.

In some embodiments, the communication apparatus 1400 may further include a transceiver 1405 and an antenna 1406. The transceiver 1405 may be referred to as a transceiver unit, a transceiving machine, or a transceiver circuit, etc., and is used to implement transceiver functions. The transceiver 1405 may include a receiver and a transmitter. The receiver may be referred to as a receiver or a receiving circuit, etc., and is configured to implement a receiving function; the transmitter may be referred to as a transmitter or a transmitting circuit, etc., and is configured to implement a transmitting function.

In some embodiments, the communication apparatus 1400 may further include one or more interface circuits 1407. The interface circuit 1407 is configured to receive code instructions and transmit them to the processor 1401. The processor 1401 executes the code instructions to enable the communication apparatus 1400 to perform the methods described in the above method embodiments.

In an implementation, the processor 1401 may include a transceiver for implementing receiving and transmitting functions. For example, the transceiver may be a transceiver circuit, an interface, or an interface circuit. The transceiver circuit, interface or interface circuit used to implement the receiving and transmitting functions may be separate or integrated. The above-mentioned transceiver circuit, interface or interface circuit may be used for reading and writing codes/data, or the above-mentioned transceiver circuit, interface or interface circuit may be used for transmitting or sending signals.

In an implementation, the processor 1401 may store a computer program 1403, and the computer program 1403, when executed on the processor 1401, may enable the communication apparatus 1400 to execute the methods described in the above method embodiments. The computer program 1403 may be embedded in the processor 1401. In this case, the processor 1401 may be implemented by hardware.

In an implementation, the communication apparatus 1400 may include a circuit, which may implement the function of sending, receiving, or communicating in the aforementioned method embodiments. The processor and transceiver described in the disclosure may be implemented on an integrated circuit (IC), an analog IC, a radio frequency integrated circuit (RFIC), a mixed signal IC, an application specific integrated circuit (ASIC), a printed circuit board (PCB), an electronic device, etc. The processor and transceiver may also be manufactured using various IC process technologies, such as complementary metal oxide semiconductor (CMOS), n-type metal oxide semiconductor (NMOS), positive channel metal oxide semiconductor (PMOS), bipolar junction transistor (BJT), bipolar CMOS (BiCMOS), silicon germanium (SiGe), gallium arsenide (GaAs), etc.

The communication apparatus described in the above embodiments may be a terminal or a network device, but the scope of the communication apparatus described in the disclosure is not limited thereto, and the structure of the communication apparatus may not be limited to FIG. 14. The communication apparatus may be a stand-alone device or may be part of a larger device. For example, the communication apparatus may be:
(1) an independent integrated circuit (IC), a chip, a chip system or a subsystem;
(2) a set of one or more ICs, which, in some embodiments, may also include a storage component for storing data and computer programs;
(3) ASIC, such as a modem;
(4) modules that may be embedded in other devices;
(5) a receiver, a terminal, an intelligent terminal, a cellular phone, a wireless device, a handheld device, a mobile unit, a vehicle-mounted device, a network device, a cloud device, an artificial intelligence device, etc.;
(6) Others, etc.

For the case where the communication apparatus may be a chip or a chip system, please refer to FIG. 15, which is a structural diagram of a chip provided in an embodiment of the disclosure. The chip in FIG. 15 includes a processor 1501 and an interface 1502. The number of processors 1501 may be one or more, and the number of interfaces 1502 may be multiple.

In some embodiments, the chip further includes a memory 1503, which is configured to store necessary computer programs and data.

Those skilled in the art can also understand that the various illustrative logical blocks and steps listed in the embodiments of the disclosure can be implemented through electronic hardware, computer software, or a combination of the two. Whether such functionality is implemented through hardware or software depends on the specific application and the design requirements of the entire system. Those skilled in the art may use various methods to implement the described functions for each specific application, but such implementation should not be understood as exceeding the protection scope of the embodiments of the disclosure.

The disclosure also provides a readable storage medium having instructions stored thereon, which implement the functions of any of the above method embodiments when executed by a computer.

The disclosure also provides a computer program product, which implements the functions of any of the above method embodiments when executed by a computer.

For the above embodiments, all or part of them can be implemented by software, hardware, firmware or any their combination. When implemented using software, all or part of the implementation may be in the form of a computer program product. The computer program product includes one or more computer programs. When the computer program is loaded and executed on a computer, the process or function described in the embodiments of the disclosure is generated in whole or in part. The computer may be a general computer, a dedicated computer, a computer network, or other programmable apparatus. The computer program may be stored in a computer-readable storage medium or transmitted from one computer-readable storage medium to another computer-readable storage medium. For example, the computer program may be transmitted from one website, computer, server, or data center to another website, computer, server, or data center via wired (e.g., coaxial cable, optical fiber, digital subscriber line (DSL)) or wireless (e.g., infrared, wireless, microwave, etc.) means. The computer-readable storage medium may be any available medium that can be accessed by a computer or a data storage device such as a server or a data center that includes one or more available media. The available medium may be a magnetic medium (e.g., a floppy disk, a hard disk, a magnetic tape), an optical medium (e.g., a high-density digital video disc (DVD)), or a semiconductor medium (e.g., a solid state disk (SSD)).

Those skilled in the art will understand that the various numerical numbers such as first and second involved in the disclosure are only for the convenience of description and are not used to limit the scope of the embodiments of the disclosure, and also indicate the order of sequence.

The “at least one” in the disclosure may also be described as “one or more”, and “multiple” can be two, three, four or more, which is not limited in the disclosure. In the embodiments of the disclosure, for a technical feature, the technical features in the technical feature are distinguished by “first”, “second”, “third”, “A”, “B”, “C” and “D”, and there is no order of precedence or size between the technical features described by “first”, “second”, “third”, “A”, “B”, “C” and “D”.

The corresponding relationships shown in the tables in the disclosure may be configured or predefined. The values of the information in each table are only examples and may be configured to other values, which are not limited by this disclosure. When configuring the correspondence between information and parameters, it is not necessarily required to configure all the correspondences illustrated in the tables. For example, in the tables in the disclosure, the corresponding relationships shown in certain rows may not be configured. For another example, appropriate deformation adjustments may be made based on the above table, such as splitting, merging, etc. The names of the parameters indicated in the titles of the above tables may also be other names understandable to the communication apparatus, and the values or representations of the parameters may also be other values or representations understandable to the communication apparatus. When implementing the above tables, other data structures may also be used, such as arrays, queues, containers, stacks, linear lists, pointers, linked lists, trees, graphs, structures, classes, heaps, hash tables, or the like.

The predefined in the disclosure may be understood as defined, predefined, stored, pre-stored, pre-negotiated, pre-configured, solidified, or pre-burned.

Those skilled in the art will appreciate that the units and algorithm steps of each example described in conjunction with the embodiments of the disclosure can be implemented by electronic hardware, or a combination of computer software and electronic hardware. Whether these functions are performed in hardware or software depends on the specific application and design constraints of the technical solution. Professionals and technicians may use different methods to implement the described functions for each specific application, but such implementation should not be considered to be beyond the scope of the disclosure.

Those skilled in the art will clearly understand that, for the convenience and brevity of description, the specific working processes of the systems, devices and units described above may refer to the corresponding processes in the aforementioned method embodiments and will not be repeated here.

The above descriptions are only specific embodiments of the disclosure, but the protection scope of the disclosure is not limited thereto. Any technician familiar with the technical field can easily think of changes or replacements within the technical scope disclosed in the disclosure, and they should all be covered by the protection scope of the disclosure. Therefore, the protection scope of the disclosure should be based on the protection scope of the claims.

1. A communication method, performed by a first device, comprising:
indicating model-related information of the first device to a second device;
wherein the model-related information comprises at least one of:
one or more artificial intelligence (AI) models supported by the first device;
one or more AI functionalities associated with the one or more AI models supported by the first device;
one or more AI functionalities supported by the first device; or
one or more AI models associated with the one or more AI functionalities supported by the first device.

2. The communication method according to claim 1, wherein indicating the model-related information of the first device to the second device comprises:
sending at least one piece of first information to the second device, wherein the at least one piece of first information indicates the one or more AI functionalities supported by the first device, and a piece of first information comprises at least one piece of second information, wherein the at least one piece of second information indicates one or more AI models supported by the first device and associated with an AI functionality indicated by the piece of first information.

3. The communication method according to claim 2, wherein pieces of second information comprised in different pieces of first information are the same or different.

4. The communication method according to claim 1, wherein indicating the model-related information of the first device to the second device comprises:
in response to an association relationship between an AI model and an AI functionality being predefined, sending at least one of at least one piece of third information or at least one piece of fourth information to the second device;
wherein the at least one piece of third information indicates the one or more AI functionalities supported by the first device, and the at least one piece of fourth information indicates the one or more AI models supported by the first device.

5. The communication method according to claim 4, wherein sending the at least one piece of third information to the second device comprises:
in response to the association relationship between an AI model and an AI functionality being a one-to-one association relationship, sending the at least one piece of third information to the second device.

6. The communication method according to claim 1, wherein indicating the model-related information of the first device to the second device comprises:
sending at least one piece of fifth information to the second device, wherein the at least one piece of fifth information indicates the one or more AI models supported by the first device, and a piece of fifth information further comprises at least one piece of sixth information, wherein the at least one piece of sixth information indicates one or more AI functionalities associated with an AI model indicated by the piece of fifth information.

7. The communication method according to claim 1, wherein indicating the model-related information of the first device to the second device comprises:
sending at least one piece of seventh information to the second device, wherein the at least one piece of seventh information indicates the one or more AI functionalities supported by the first device;
receiving identifier (ID) information sent by the second device, wherein the ID information comprises: one or more IDs assigned respectively by the second device to the one or more AI functionalities supported by the first device; and
sending at least one piece of eighth information to the second device, wherein the at least one piece of eighth information indicates the one or more AI models supported by the first device, and a piece of eighth information further comprises at least one piece of ID information, wherein the at least one piece of ID information comprises: one or more IDs respectively corresponding to one or more AI functionalities associated with an AI model indicated by the piece of eighth information.

8. The communication method according to claim 1, wherein the model-related information further comprises: one or more application scenarios for the one or more AI models supported by the first device.

9. The communication method according to claim 1, wherein the first device is a device deploying or storing the one or more AI models, and the second device is a device to manage the one or more AI models in the first device.

10. A communication method, performed by a second device, comprising:
determining model-related information of a first device based on an indication from the first device;
wherein the model-related information comprises at least one of:
one or more artificial intelligence (AI) models supported by the first device;
one or more AI functionalities associated with the one or more AI models supported by the first device;
one or more AI functionalities supported by the first device; or
one or more AI models associated with the one or more AI functionalities supported by the first device.

11. The communication method according to claim 10, wherein determining the model-related information of the first device based on the indication from the first device comprises:
receiving at least one piece of first information from the first device, wherein the at least one piece of first information indicates the one or more Al functionalities supported by the first device, and a piece of first information comprises at least one piece of second information, wherein the at least one piece of second information indicates one or more AI models supported by the first device and associated with an AI functionality indicated by the piece of first information.

12. The communication method according to claim 11, wherein pieces of second information comprised in different pieces of first information are the same or different.

13. The communication method according to claim 10, wherein
determining the model-related information of the first device based on the indication from the first device comprises:
in response to an association relationship between an AI model and an AI functionality being predefined, receiving at least one of at least one piece of third information or at least one piece of fourth information from the first device;
wherein the at least one piece of third information indicates the one or more AI functionalities supported by the first device, and the at least one piece of fourth information indicates the one or more AI models supported by the first device.

14. The communication method according to claim 13, wherein receiving the at least one piece of third information from the first device comprises:
in response to the association relationship between an AI model and an AI functionality being a one-to-one association relationship, receiving the at least one piece of third information from the first device.

15. The communication method according to claim 10, wherein determining the model-related information of the first device based on the indication from the first device comprises:
receiving at least one piece of fifth information from the first device, wherein the at least one piece of fifth information indicates the one or more AI models supported by the first device, and a piece of fifth information further comprises at least one piece of sixth information, wherein the at least one piece of sixth information indicates one or more AI functionalities associated with an AI model indicated by the piece of fifth information.

16. The communication method according to claim 10, wherein determining the model-related information of the first device based on the indication from the first device comprises:
receiving at least one piece of seventh information from the first device, wherein the at least one piece of seventh information indicates the one or more AI functionalities supported by the first device;
sending identifier (ID) information to the first device, wherein the ID information comprises: one or more IDs assigned respectively by the second device to the one or more AI functionalities supported by the first device; and
receiving at least one piece of eighth information from the first device, wherein the at least one piece of eighth information indicates the one or more AI models supported by the first device, and a piece of eighth information further comprises at least one piece of ID information, wherein the at least one piece of ID information comprises: one or more IDs respectively corresponding to one or more AI functionalities associated with an AI model indicated by the piece of eighth information.

17-20. (canceled)

21. A first device, comprising:
a processor; and
a memory storing instructions executable by the processor,
wherein the processor is configured to:
indicate model-related information of the first device to a second device;
wherein the model-related information comprises at least one of:
one or more artificial intelligence (AI) models supported by the first device;
one or more AI functionalities associated with the one or more AI models supported by the first device;
one or more AI functionalities supported by the first device; or
one or more AI models associated with the one or more AI functionalities supported by the first device.

22. (canceled)

23. A non-transitory computer-readable storage medium for storing instructions, which, when executed, cause the communication method according to claim 1 to be implemented.

24. A second device, comprising:
a processor; and
a memory storing instructions executable by the processor,
wherein the processor is configured to perform the communication method according to claim 10.

25. A non-transitory computer-readable storage medium for storing instructions, which, when executed, cause the communication method according to claim 10 to be implemented.
